(19) United States
(12) Patent Application Publication
(10) Pub. No.: US 2011/0155934 A1
(43) Pub. Date: Jun. 30, 2011

(54) Automatic bathroom flushers

(76) Inventors: Fatih Guler, Winchester, MA (US); Kay Herbert, Winthrop, MA (US); Jean F. Daher, Auburn, MA (US); Xiaoxiong Mo, Lexington, MA (US); John R. Wilson, Naperville, IL (US); Natan E. Parsons, Brookline, MA (US); Amy Parsons, Brookline, MA (US)

(21) Appl. No.: 12/927,293

(22) Filed: Nov. 10, 2010

Related U.S. Application Data
(63) Continuation-in-part of application No. 12/655,696, filed on Jan. 4, 2010.
Application No. 12/655,696 is a continuation of application No. PCT/US2008/008242, filed on Jul. 3, 2008.
Application No. 12/655,696 is a continuation-in-part of application No. 11/716,546, filed on Mar. 9, 2007, now abandoned.
Application No. 11/716,546 is a continuation of application No. 10/783,701, filed on Feb. 20, 2004, now Pat. No. 7,188,822.
Application No. 10/783,701 is a continuation-in-part of application No. 12/288,331, filed on Oct. 18, 2008.
Application No. 12/288,331 is a division of application No. 10/859,750, filed on Jun. 3, 2004, now Pat. No. 7,437,778.
Application No. 10/859,750 is a continuation of application No. PCT/US02/38758, filed on Dec. 4, 2002.
Application No. PCT/US02/38758 is a continuation-in-part of application No. 12/798,667, filed on Apr. 8, 2010.
Application No. 12/798,667 is a continuation of application No. 11/159,422, filed on Jun. 22, 2005, now abandoned.
Application No. 11/159,422 is a continuation of application No. PCT/US03/41303, filed on Dec. 26, 2003.
Application No. PCT/US03/41303 is a continuation-in-part of application No. PCT/US03/38730, filed on Dec. 4, 2003.
(60) Provisional application No. 61/280,862, filed on Nov. 10, 2009.
(60) Provisional application No. 60/958,358, filed on Jul. 3, 2007.
(60) Provisional application No. 60/999,591, filed on Oct. 19, 2007.
(60) Provisional application No. 60/448,995, filed on Feb. 20, 2003.
(60) Provisional application No. 60/424,378, filed on Nov. 6, 2002.
(60) Provisional application No. 60/391,282, filed on Jun. 24, 2002.
(60) Provisional application No. 60/362,166, filed on Mar. 5, 2002.
(60) Provisional application No. 60/513,722, filed on Oct. 22, 2003.

(51) Int. Cl. F16K 31/02

(52) U.S. Cl. 251/129.04

(57) ABSTRACT

An automatic toilet room flusher system includes a flusher having a valve body, a valve member, an electronic control module and a control panel. The valve body includes a flusher inlet and a flusher outlet and a valve seat located inside the valve body. The valve member is cooperatively arranged with the valve seat and is constructed and arranged to control water flow between the flusher inlet and the flusher outlet. The electronic control module includes a sensor and a controller. The control panel is mounted with respect to a bathroom wall and is designed to accommodate the electronic control module behind the wall.

This application claims priority from U.S. Provisional Application 61/280,862, filed on Nov. 10, 2010, entitled “Automatic Bathroom Flushers.”

This application is also a continuation-in-part of U.S. application Ser. No. 12/655,696, filed on Jan. 4, 2010, which is a continuation of PCT Application PCT/US2008/008242, filed on Jul. 3, 2008, which claims priority from U.S. Provisional Application 60/958,358 filed on Jul. 3, 2007, and claims priority from U.S. Provisional Application 60/999,591 filed on Oct. 19, 2007, and is also a continuation-in-part of U.S. application Ser. No. 11/716,546, filed on Mar. 9, 2008, which is a continuation of U.S. application Ser. No. 10/783,701, filed on Feb. 20, 2004, now U.S. Pat. No. 7,188,822, which claims priority, from U.S. Prov. Application 60/448,995, filed on Feb. 20, 2003.

This application is also a continuation-in-part of U.S. application Ser. No. 12/288,331, filed on Oct. 18, 2008, which is a divisional of U.S. application Ser. No. 10/859,750, now U.S. Pat. No. 7,437,778, which is a continuation of PCT Application PCT/US02/38758, filed on Dec. 4, 2002, entitled “Automatic Bathroom Flushers” which also claims priority from U.S. Prov. Application 60/424,378, filed Nov. 6, 2002, U.S. Prov. Application 60/391,282, filed Jun., 24, 2002, U.S. Prov. Application 60/362,166, filed on Mar. 5, 2002.

This application is also continuation-in-part of U.S. application Ser. No. 12/798,667, filed on Apr. 8, 2010, which is a continuation of U.S. application Ser. No. 11/159,422 filed on Jun. 22, 2005, which is a continuation of PCT Application PCT/US03/041303, filed on Dec. 26, 2003, entitled “Optical Sensors and Algorithms for Controlling Automatic Bathroom Flushers and Faucets,” which is a continuation-in-part of PCT Application PCT/US03/38730, entitled “Passive Sensors for Automatic Faucets and Bathroom Flushers” filed on Dec. 4, 2003, which claims priority from U.S. Prov. Application 60/513,722, entitled “Automatic Faucets with Novel Flow Control Sensors,” filed on Oct. 22, 2003. All the above-listed patent applications are incorporated by reference.

### FIELD OF THE INVENTION

The present inventions are directed to automatic bathroom flushers for toilets and urinals.

### BACKGROUND OF THE INVENTION

Automatic bathroom flushers have become increasingly prevalent, particularly in public restrooms, both for flushing toilets and urinals. Such flushers contribute to hygiene, facility cleanliness and water conservation.

There are several types of tankless bathroom flushers on the market including flushers supplied by Sloan Valve Company, for example, sold as ROYAL® or GEM® flush valves. ROYAL® flush valves may be manually operated, or automatically operated using OPTIMA® controllers and infrared sensors. In general, bathroom flushers receive a pressurized water supply at an input and provide flush water at an output during a flush cycle. The flush cycle provides a predetermined amount of water (depending on the external water pressure) even though there is no water tank.

In manual flushers, users initiate a flushing cycle by displacing a handle that controls a flushing mechanism including a piston or a flexible diaphragm. The handle movement causes a water leak from a control or pilot chamber to the flusher's output, which lowers pressure in the pilot chamber. Due to the lower pressure, the external water pressure lifts the flusher's piston or diaphragm from a valve seat thereby enabling water flow. The stroke of the piston or diaphragm controls the volume of water passing through the flush valve. After some time, the pressure in the pilot chamber increases (through a control passage) forcing the piston or diaphragm onto the valve seat and thus terminating the water flow. The manual flush valves are described in U.S. Pat. Nos. 3,778,023; 5,881,993; 5,295,655, all of which are incorporated by reference for explanation and better understanding.

In automatic flushers, an object sensor initiates the flushing cycle, where an actuator opens a relief passage enabling water flow from the pilot chamber to the flusher's output. This flow lowers pressure in the pilot chamber. Due to the lower pressure, as mentioned above, the external pressure lifts the flusher's piston or diaphragm from a valve seat thereby enabling main water flow used for flushing. After the actuator seals the relief passage, the pressure in the pilot chamber increases forcing the piston or diaphragm onto the valve seat and thus closing the water flow. Manual flush valves (e.g., ROYAL® flush valves) may be converted into automatically operated valves using a controller and sensor unit, sold under the name OPTIMA® by Sloan Valve Company. Overall, the flush valves supplied by Sloan Valve Company are durable, highly reliable, and suitable for long-term operation.

There is, however, a need for improved automatic flushers due to a high demand for flushers and their need in thousands of restrooms.

### SUMMARY OF THE INVENTION

The present inventions are directed to automatic bathroom flushers for toilets and urinals. The present inventions are also directed to automatic novel bathroom flushers enabling easy servicing and adjustments for optimal operation.

According to one aspect, the present invention is an automatic bathroom flusher located behind a bathroom wall. The bathroom flusher includes a flusher body, a valve assembly, an electronic control system, and a flusher cover. The flusher body includes an inlet and an outlet, and is designed to accommodate a valve assembly (e.g., a flush valve mechanism) that controls water flow between the inlet and the outlet. The valve assembly includes a valve member movable with respect to a valve seat providing a sealing action based on applied water pressure on the valve assembly.

According to one preferred embodiment, the automatic bathroom flusher includes a control module concealed behind a control wall panel mounted with respect to a bathroom wall. According to another preferred embodiment, the automatic bathroom flusher includes the bathroom flusher and the control module both concealed behind a control wall panel mounted with respect to a bathroom wall. In both embodiments, the valve assembly (flush valve mechanism) includes a valve member operating between open and closed positions and being is controlled by water pressure inside a pilot chamber. The valve member may include a piston, a diaphragm, or a fram piston.

According to one preferred embodiment, the valve assembly permits adjustment of the stroke of the valve assembly in order to control the volume of water passing through the flush valve in a single operation. The valve assembly may include a diaphragm assembly constructed and arranged to permit adjustment of the stroke of the diaphragm to control the volume of water passing through the flush valve in a single operation. This design provides a reliable and simply operable stroke adjustment for a diaphragm-type flush valve. The valve assembly includes preferably a single element that may be rotated to several different positions, with each position providing a different stroke or degree of movement of the assembly. Furthermore, this design provides a flush valve that has both a coarse stroke and a fine stroke adjustment. The flusher may utilize a controller having several different selections or positions for fine adjustment and a volume regulator having variable sized flanges to provide a coarse adjustment for the diaphragm stroke.

Preferably, in the bathroom flusher, the valve member includes a fram assembly, as described in the PCT Applications PCT/US02/38758 and PCT/US02/41576, both of which are incorporated by reference. The fram assembly includes a fram piston sliding within a guiding enclosure, wherein the fram piston is constructed to move to an open position enabling fluid flow from the fluid input port to the fluid output port upon reduction of pressure in a fram chamber; and is constructed to move to a closed position, upon increase of pressure in the fram chamber The fram piston may include a sliding seal. The sliding seal may be a one-sided seal. The sliding seal may be a two-sided seal. The bathroom flusher includes an electromagnetic actuator constructed and arranged to release pressure in the fram chamber and thereby initiate movement of the fram piston from the closed position to the open position.

Preferably, the automatic bathroom flusher includes an external sensor for detecting a user. The external sensor may be an optical sensor, an ultrasound sensor, a heat sensor (detecting body heat), a capacitive sensor (detecting capacitance changes due to user's body), or a combination thereof. The optical sensor includes an optical window associated with the control wall panel. The optical sensor may include an active sensor including a light emitter and a light detector (receiver) for receiving light reflected from a user or bathroom environment (e.g., bathroom walls, stalls, or plumbing). The active optical sensor is described in PCT Applications PCT/US02/38758 and PCT/US02/41576, both of which are incorporated by reference.

The optical sensor may include a passive sensor including a light detector for detecting ambient light in the range of 350 nm to 1500 nm, and preferably in the range of 500 nm to 950 nm. The light detector may include a photoresistor, or a photodiode as described in PCT Applications PCT/US03/38730 and PCT/US03/41303, both of which are incorporated by reference.

Alternatively, the sensor is a near-infrared sensor that detects optical radiation in the range of about 800 nm to about 1500 nm. Alternatively, the sensor is a presence sensor. Alternatively, the sensor is a motion sensor that detects first arrival and later departure of a user before flushing a toilet or a urinal.

According to another aspect, the present invention is an automatic bathroom flusher system including a valve body including an inlet and an outlet and a valve seat inside the body and a valve member cooperatively arranged with the valve seat, the valve member being constructed and arranged to control water flow between the inlet and the outlet. The automatic bathroom flusher system also includes an electronic control module comprising a sensor and a controller. The automatic bathroom flusher system also includes a control panel mounted with respect to a bathroom wall and designed to accommodate the electronic control module behind the bathroom wall.

Preferably, the automatic bathroom flusher system also includes a manual override including a hydraulic actuator. The automatic bathroom flusher system may also include a photovoltaic cell mounted with respect to the control panel. The control panel may cooperatively designed with a receptacle mounted behind the bathroom wall. The automatic bathroom flusher system may also include an object sensor mounted on the control panel and constructed and arranged to provide a signal to the controller.

### BRIEF DESCRIPTION OF THE DRAWINGS

FIG. 1 illustrates a perspective view of a bathroom wall including a control wall panel covering a concealed automatic bathroom flusher for flushing a toilet.

FIG. 1A illustrates a perspective view of a bathroom wall including another embodiment of a control wall panel covering a concealed automatic bathroom flusher for flushing a toilet.

FIGS. 2 and 2A illustrate the bathroom wall and the toilet shown in FIG. 1 having the control wall panel removed thus exposing the automatic bathroom flusher for flushing the toilet.

FIG. 3 illustrates a rear view of the control wall panel of FIG. 1 and the automatic bathroom flusher shown in FIGS. 2 and 2A.

FIGS. 3A and 3B illustrate a rear view of another embodiment of the control wall panel including a rack and pinion mechanism for attaching the control wall panel to a receptacle mounted on a bathroom wall behind which the automatic bathroom flusher is located.

FIG. 4 illustrates a perspective rear view of the automatic bathroom flusher partially located in a receptacle behind the bathroom wall.

FIG. 4A illustrates a partial enlarged view of an attachment system for attaching the control wall panel to the receptacle located behind the bathroom wall.

FIG. 5 illustrates a partially perspective and cross-sectional view of the automatic bathroom flusher shown in FIG. 4.

FIG. 5A is cross-sectional view of the automatic bathroom flusher shown in FIG. 5.

FIG. 5B is cross-sectional view of a diaphragm insert used in the automatic bathroom flusher of FIG. 5 and FIG. 5A.

FIG. 6 is a front perspective view of a hydraulic actuator used in the automatic bathroom flusher.

FIG. 6A is a rear perspective view of a hydraulic actuator used in the automatic bathroom flusher.

FIG. 6B illustrates a cross-sectional view of a mechanical coupling of the hydraulic actuator, shown in FIGS. 6 and 6A, to a manual button mounted on the control wall panel shown in FIG. 1.

FIG. 7 illustrates a side view of the control wall panel including an electronic module, a photovoltaic panel, and a manual button mounted on the control wall panel shown in FIG. 1.

FIG. 7A illustrates an enlarged side view the mounting of an intrared sensor used in the electronic module shown in FIG. 7.

FIG. 7B illustrates an enlarged side view of the manual button shown in FIG. 7 as mounted on the control wall panel shown in FIG. 1 and FIG. 7.

FIGS. 8 and 8A illustrate a perspective view of another embodiment of the control wall panel covering an automatic bathroom flusher concealed behind a bathroom wall and used for flushing a toilet.

FIG. 9 illustrates diagrammatically control electronics and components used in the automatic bathroom flusher.

FIG. 10 illustrates diagrammatically control electronics and components used in another embodiment of the automatic bathroom flusher.

### DETAILED DESCRIPTION OF ILLUSTRATED EMBODIMENTS

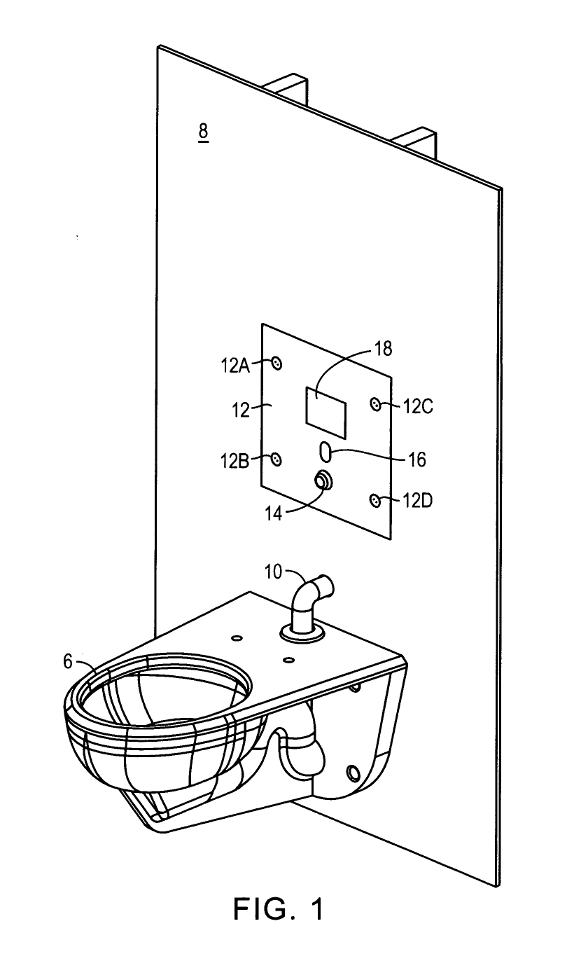

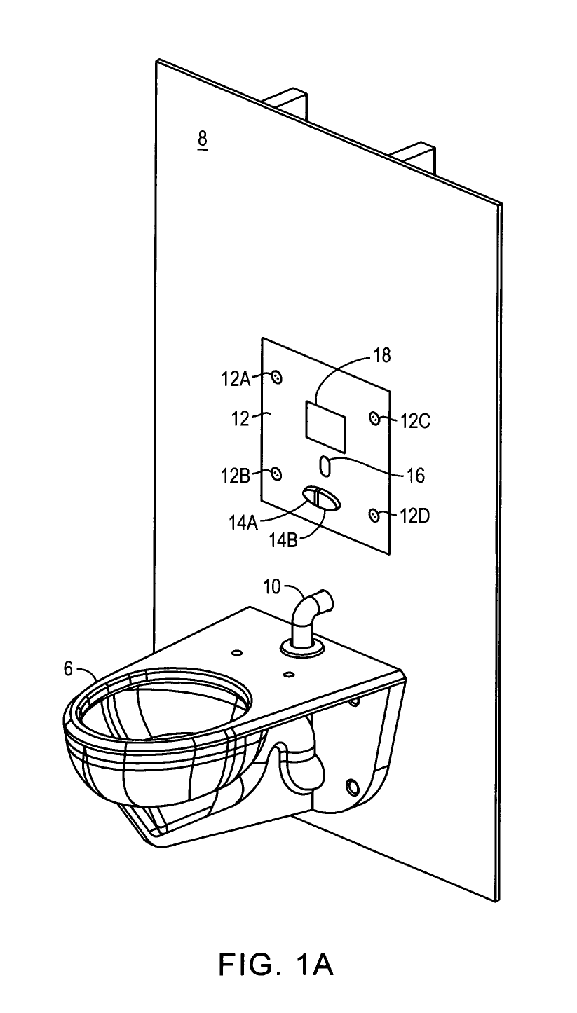

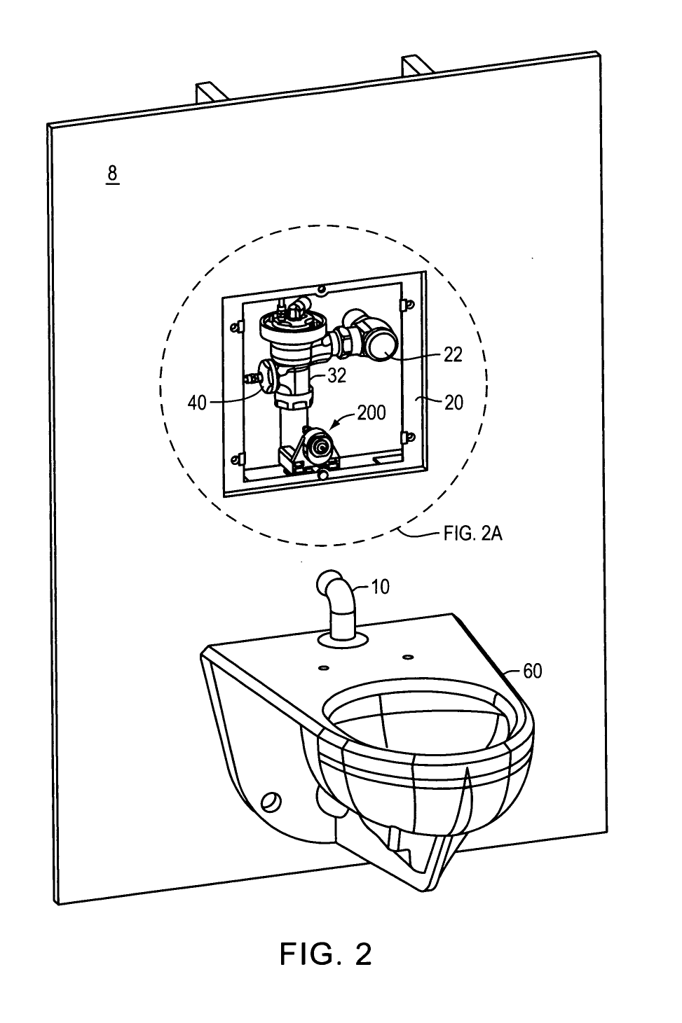

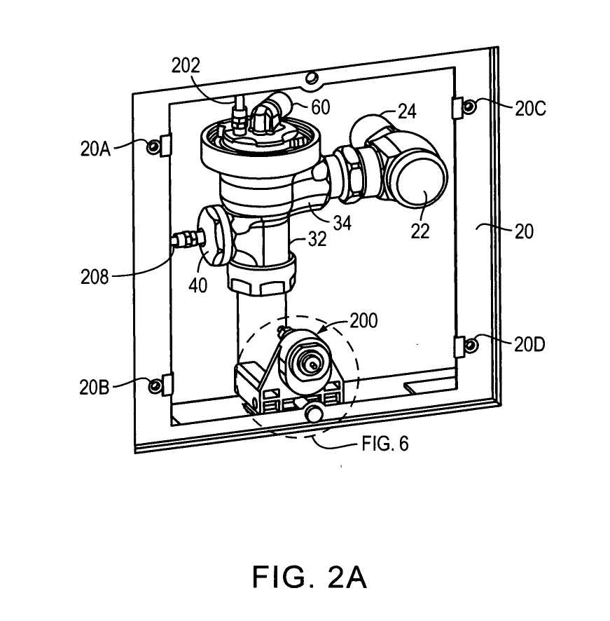

FIG. 1 depicts a toilet 6 and a bathroom wall 8 including a control wall panel 12 covering a concealed automatic bathroom flusher for flushing toilet 6. Control wall panel 12 includes a manual activation button 14, an optical sensor window 16, and a photovoltaic cell 18. Control wall panel 12 in held place using bolts or screws 12A, 12B, 12C, and 12D cooperatively designed with nuts 20A, 20B, 20C, and 20D shown in FIG. 2A.

FIG. 1A depicts a toilet 6 and a bathroom wall 8 including control wall panel 12A covering a concealed automatic bathroom flusher for flushing toilet 6. Control wall panel 12A includes two manual activation buttons 14A and 14B for dual flush actuation of the concealed automatic bathroom flusher providing water to toilet 6 via a water pipe 10.

FIG. 2 depicts toilet 6 and bathroom wall 8 having control wall panel 12 removed and exposing the automatic bathroom flusher and hydraulic actuator 200. FIG. 2A is an enlarged view of the installation located behind wall 8 and partially enclosed by a receptacle 20.

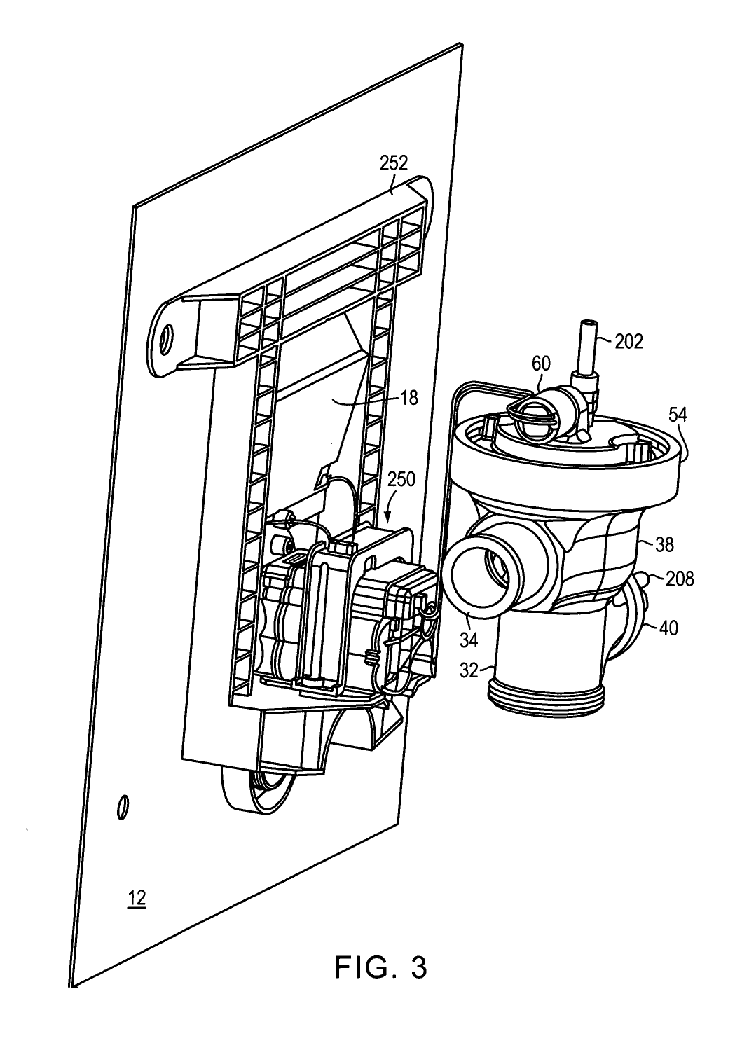

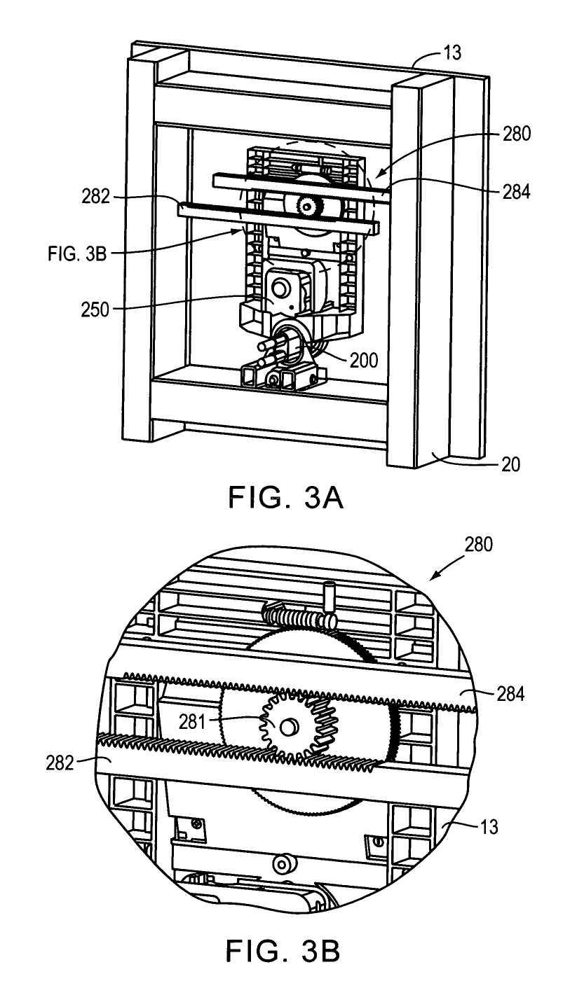

FIG. 3 is a rear view of control wall panel 12 showing a mounting structure 252 for mounting photovoltaic cell 18 and mounting electronic module 250. FIG. 3 also depicts the automatic bathroom flusher.

FIGS. 3A and 3B illustrate another embodiment of control wall panel 12 including a rack and pinion mechanism 280 for attaching the control wall panel to receptacle 20. Rack and pinion mechanism 280 includes displaceable bars 282 and 284 for locking control wall panel 12 in place instead of using screws 12A, 12B, 12C, and 12D (shown in FIG. 1).

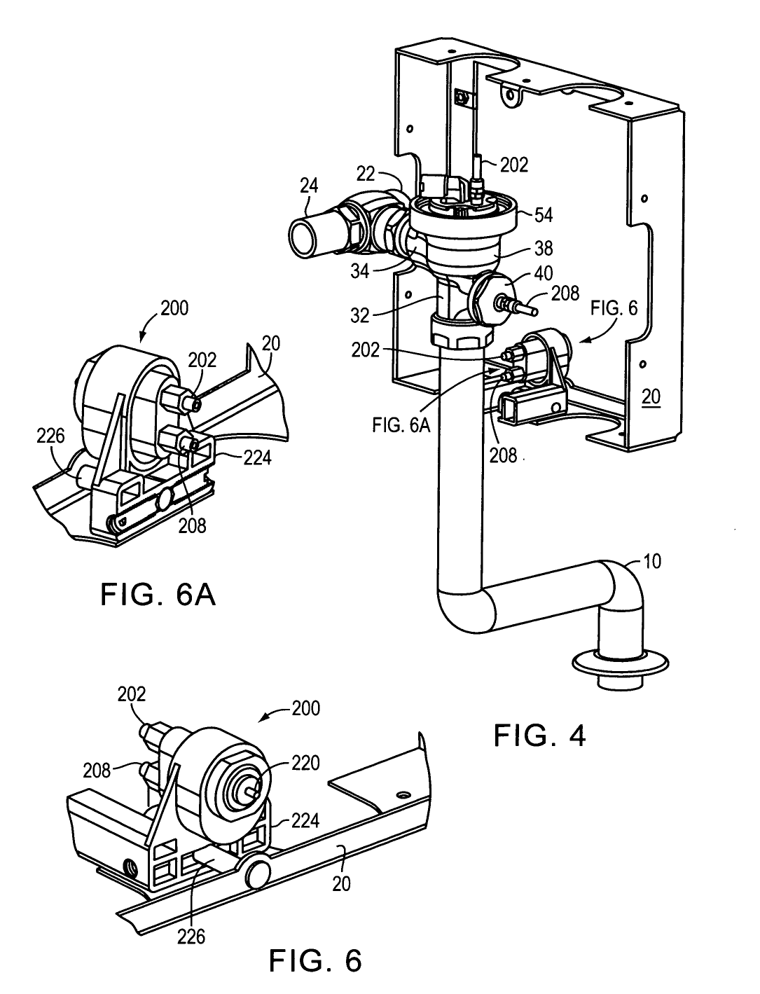

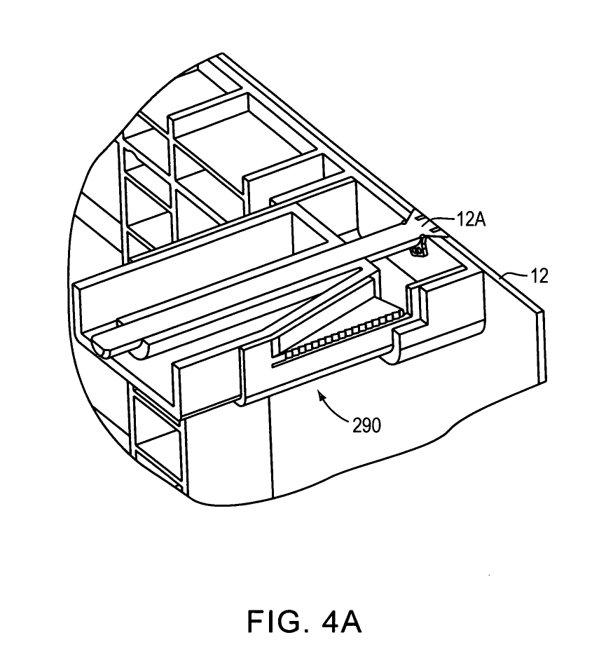

FIG. 4 depicts the automatic bathroom flusher and a hydraulic actuator 200 from a rear view and FIG. 4A depicts a partial enlarged view of an attachment system 290 for attaching control wall panel 12 to receptacle 20 (FIG. 4) located behind bathroom wall 8.

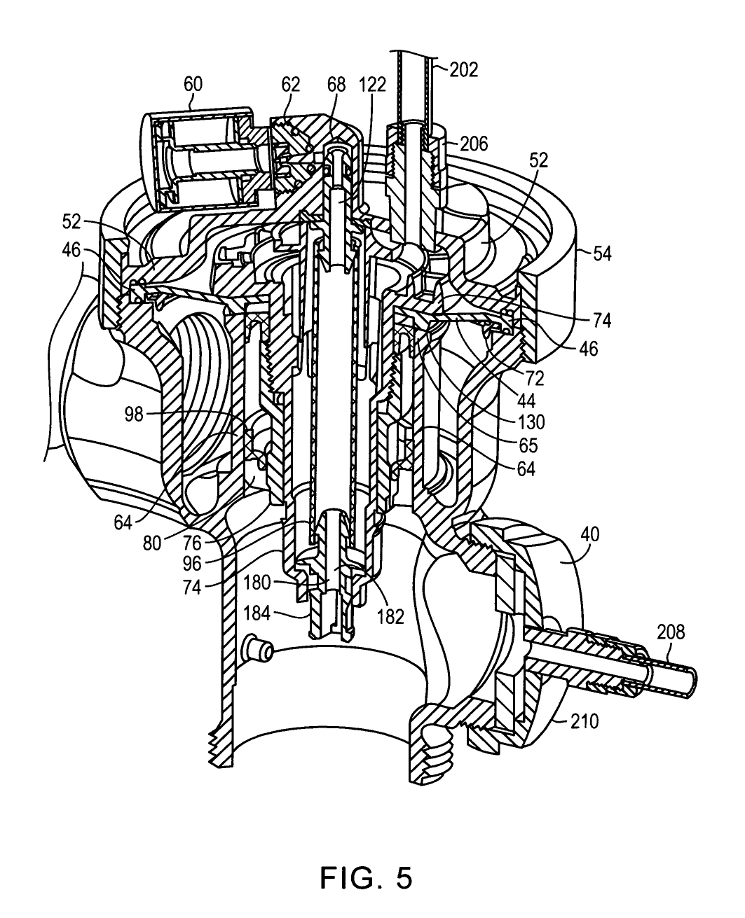

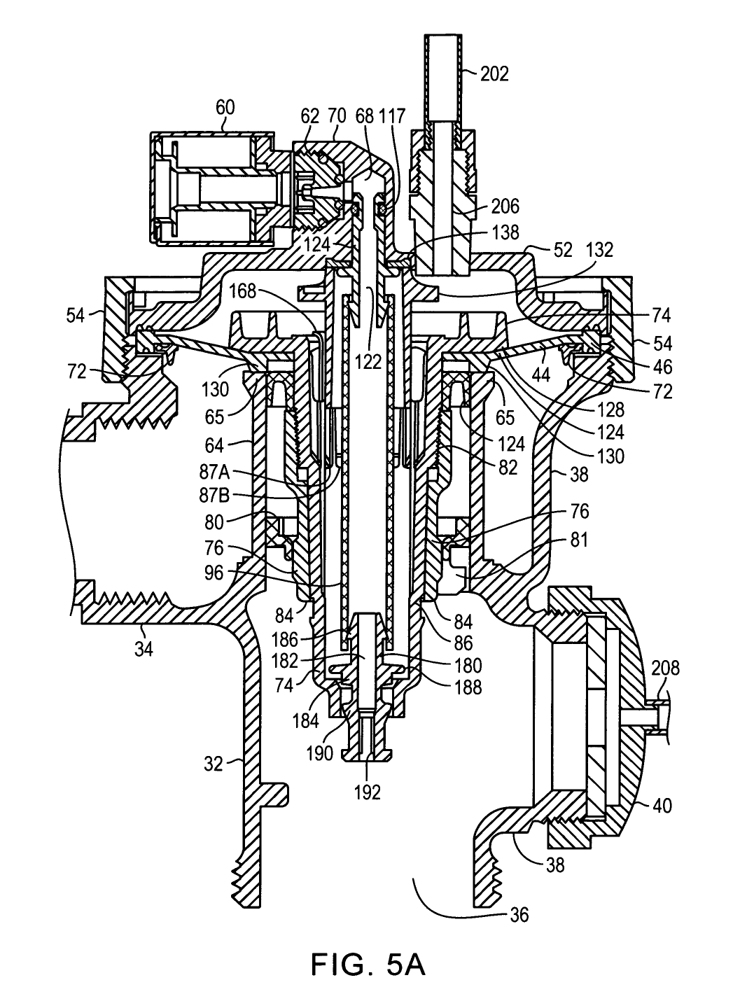

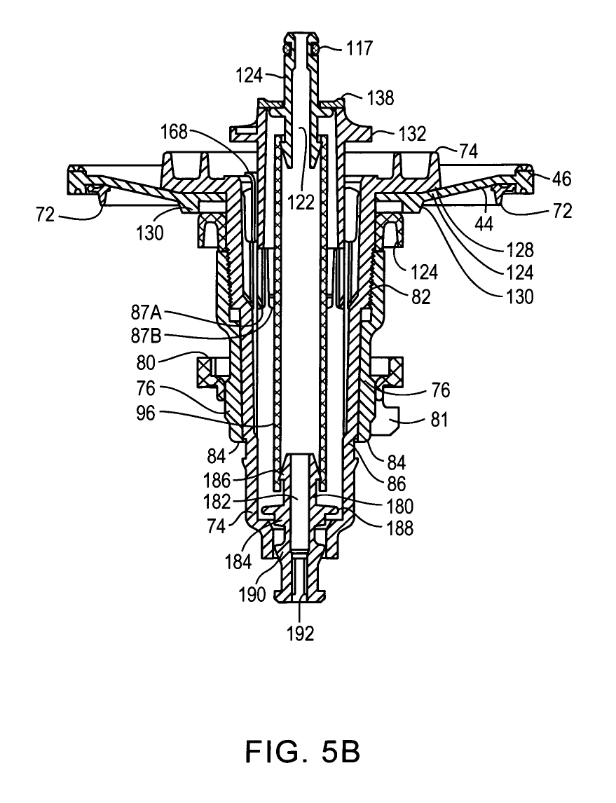

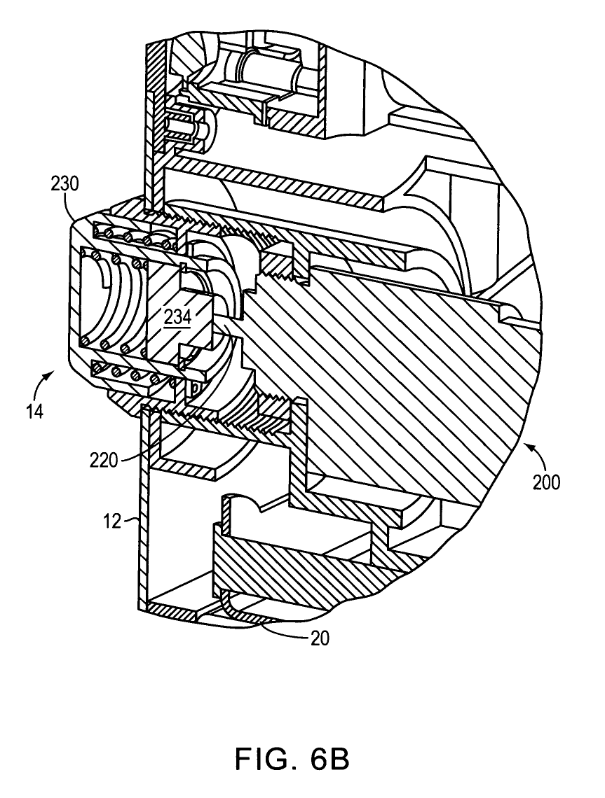

FIG. 5 is a partially perspective and partially cross-sectional view of the automatic bathroom flusher shown in FIGS. 2A, 3, and 4. FIG. 5A is cross-sectional view of the automatic bathroom flusher shown in FIG. 5. The automatic bathroom flusher includes a flush valve body 38 with an inlet opening 34 and an outlet opening 32. The automatic bathroom flusher also includes a boss 38 (FIG. 5A) and this normally is the location of the flush valve manual handle. However, in the present design, a cap 40 encloses this opening and provides connection to a hydraulic line 208 connected to hydraulic actuator 200 (see FIG. 6A). The valve shown is of the type sold by Sloan Valve Company under the trademark ROYAL, but any similar valve may be used.

Referring still to FIGS. 5 and 5A, the automatic bathroom flusher also includes a diaphragm valve assembly shown in FIG. 5B, which is described in detail in U.S. Pat. No. 7,124,997, which is incorporated by reference. The diaphragm valve assembly includes a diaphragm 44 held at its periphery 46 on the body shoulder by a flange 54 and an inner cover 52 (i.e., a pilot cover 52 forming a dome). Electromagnetic, solenoid actuator 60 is attached to inner pilot cover 52 at the dome extension 70. Diaphragm 44 and inner pilot cover 52 form a piloting chamber for controlling the flushing action. That is, the volume between the underside of inner pilot cover 52 and the upper side of the diaphragm 44 forms a pressure/pilot chamber. The pressure of the water within this pilot chamber holds the diaphragm 44 at location 168 upon a seat 65 formed at the upper end of the barrel 64 of the valve body which forms a conduit between the inlet and the outlet.

Referring still to FIGS. 5 and 5A, there is a vent passage in inner pilot cover 52 which connects the pressure chamber (i.e., the pilot chamber) and the chamber 68 in dome extension 70, with the flow of water between the vent passage and the chamber 68 being controlled by solenoid 60. Details of this operation are disclosed in U.S. Pat. Nos. 4,309,781 and 4,793,588, which are incorporated by reference. Water flow through the inlet reaches the pressure chamber through a filter and bypass ring, the details of which are disclosed in U.S. Pat. No. 5,967,182, which is incorporated by reference. Thus, water from the flush valve inlet reaches the pressure chamber, to maintain the diaphragm in a closed position, and the pressure chamber will be vented by the operation of the solenoid as water will flow upwardly through passage, then into upper chamber 68, and then through the passage in a flex tube 96 to be described hereinafter.

Referring still to FIGS. 5 and 5A, the diaphragm assembly includes the diaphragm which, in its closed position, will rest upon the seat 40 and a disk 86. The disk 74 is threadedly attached to a guide 82 which carries a flow control ring 80 which is adjacent the interior of the barrel 42. Directly below the flow control ring 80, the guide includes arcuate projections 58 which support ring 80. In addition to the threaded connection 60 between the guide 54 and the disk 86, the guide carries pairs of inwardly-directed barbs 62, annular in form, which extend within a recess 64 in the exterior of the disk to lock these elements in an assembled and fixed position. At the lower end of guide 74 there is an inwardly-directed shoulder 184, which functions to support a lower flex tube adapter 190, as is also illustrated in U.S. Pat. 6,382,586, which is incorporated by reference. The adapter 68 includes a body 70 and an upwardly-directed nose 72 which will extend into and secure the lower end of a flex tube 96. The nose 72 has a barb 76 which deforms the flex tube and functions to positively hold the lower end of the flex tube to the adapter. The body 70 includes an outwardly-directed flange 78, which rests upon the inwardly-directed shoulder 66 of the guide and there is a seal ring 80 which is located within an outwardly-facing groove in the adapter and bears against the interior of the guide.

A portion 82 of the adapter 68 extends outwardly from the guide and has a shoulder 84 to effectively hold the adapter 68 to the lower end of the guide, with only minimal movement permitted. The adapter 68 has a central water passage 86 which communicates with a central passage 88 in the portion 82 of the adapter. Thus, any water flowing down through the flex tube 96 will pass out of the adapter and be directed toward the flush valve outlet 36.

The flex tube 96, which is hollow and in the form of a flexible sleeve that may contain a coil spring, which prevents the tube from collapsing due to water pressure flowing downwardly through the disk 86. At its upper end, the flex tube is attached to an inner cover adapter 124. The adapter 124 may have one or more outwardly-extending projections 94 which interact with and may deform the interior of the flex tube wall to secure the adapter in position. The upper nose of the adapter 124 is tapered and has an 0-ring 117 which forms a seal with an interior wall 96 in an extension 98 of the cover 30. The adapter 124 thus extends within the chamber 46 and forms part of the fluid connection from the chamber 46, down through the interior passage 122 of the adapter, and into the interior of the flex tube 96 through which water flows, from the pressure chamber to the flush valve outlet 36.

Seated on top of the upper end of the guide 54 is a refill head 123, with the diaphragm 22 being captured between the upper surface of the refill head and a lower surface 104 of a radially outwardly-extending portion 106 of the disk 86. The diaphragm, disk 86 and guide 54 will all move together when pressure is relieved in chamber 38 and the diaphragm moves upwardly to provide a direct connection between the flush valve inlet 34 and flush valve outlet 36. When this takes place, the disk 86 will move up and will carry with it the lower end of the flex tube 96. Thus, the flex tube must bend as its upper end is fixed within the passage 96 of the cover 30.

The upward movement of the diaphragm, or the stroke of the valve assembly, controls the amount of water passing through the flush valve during operation. Water flows into the pressure chamber 38 through the bypass orifice in the diaphragm, which is in communication with the flush valve inlet 34. The length of time in which it takes for the pressure chamber 38 to fill, forcing the diaphragm back upon its seat 40, determines the volume of water that will flow through the flush valve. The distance the diaphragm moves upwardly off its seat, the stroke of the valve assembly, is adjustable and is determined by a micro-control adjuster and a volume regulator.

The inside cylindrical surface 112 of the disk 86 has a plurality (e.g., twelve) downwardly-extending ribs 87A. The ribs are arranged in three groups of four. Within each group of four the ribs vary in position at their upper end, as illustrated in detail in U.S. Pat. No. 7,124,997. For example, the distance from the top of a rib 116 to the upper surface of an annular rim 118 may be 0.273 in. The distance between a rib 120 to the top of the rim 118 may be 0.283 in. The distance from the top of a rib 122 to the rim 118 may be 0.293 in and finally, the distance from the top of a rib 124 to the rim 118 may be 0.303 in. There are thus three ribs of equal height, one within each of the three groups. The micro-control adjuster, indicated at 126, has three equally spaced downwardly-facing slots 128. When the micro-control adjuster is inserted within the disk 86, each of the slots 128 will interact with a rib in one of the three sets. The end result of this cooperating relationship is that the upper surface 168 of the micro-control adjuster may be located at four different heights. As described in U.S. Pat. No. 7,124,997, there may be indicia tabs, with the numbers 1, 2, 3 and 4 to designate how the micro-control adjuster may be positioned relative to the disk 86 in order to establish the four different heights for the upper surface 168 of the micro-control adjuster.

The micro-control adjuster is inserted within the disk 86 at one of the four designated positions. Or the micro-control adjuster may be left out entirely, which would establish a fifth fine adjustment height for controlling the stroke of the diaphragm assembly. The micro-control adjuster will be snapped in, either during assembly of the valve at the factory, or by the installer, depending upon the particular type of fixture with which the flush valve will be used. The installer will determine the position of the micro-control adjuster, depending upon the volume of water which is to pass through the flush valve during operation of a particular fixture. The micro-control adjuster has a plurality of tabs 134 which provide a degree of flexibility, allowing the micro-control adjuster to be inserted within the guide, but easily removable. The indicia tabs provide the upper surface 168 which will function as a stop with the volume regulator, as described hereinafter.

The volume regulator, shown in FIGS. 5A and 5B, is indicated at 133 and has an outwardly-extending annular shoulder 136, the lower surface 138 of which functions as the stop limiting upward movement of the diaphragm assembly and the micro-control adjuster. The surface 168 will contact the surface 138 and the distance through which the surface 168 moves before such contact determines the stroke of the flush valve. The micro-control adjuster provides a fine stroke adjustment and the height of the shoulder 136, the lower surface of which functions as a stop may provide a coarse adjustment of stroke. Different volume regulators may be utilized, each of which may have a different height for the shoulder 136, with the height of the shoulder determining the location of the surface 138 which in turn limits the upward movement of the diaphragm assembly.

The volume regulator will be attached to the inner cover adapter 124 by means of an outwardly-extending shoulder 140 on the adapter and an inwardly-extending flange 142 on the volume regulator. The volume regulator is attached to the inner cover adapter 124, which in turn is fixed in position relative to the inner cover 30. Since the volume regulator is fixed in position relative to the inner cover, the upper stop formed by the shoulder 136 will also be fixed. The distance the valve assembly or the diaphragm may move, or its stroke, is determined by the space between the surface 168 and the underside 138 of the volume regulator. Coarse adjustment is provided by the height of the shoulder 136. Fine adjustment is provided by the position of the micro-control adjuster within the disk 86 and as described, there may be four such positions of the disk, each one providing a different location for the upper surface 168. The fifth location of adjustment is provided by removal of the micro-control adjuster, in which case the shoulder 136 will be contacted by the rim 118 as the diaphragm assembly moves upwardly. This provides the greatest stroke of the flush valve.

The stroke of the valve assembly, in the case shown herein, a diaphragm-type valve assembly, determines the volume of water delivered during a flushing cycle. Different types of toilet fixtures require different flushing volumes and the present invention provides both a coarse and fine adjustment of the diaphragm as it moves between open and closed positions. The components used herein to provide stroke adjustment may be made of a suitable plastic, eliminating potential corrosion, and may be easily adjusted with a minimum of parts and with a minor degree of education by the individual installing the flush valve. The stroke adjustment and the parts used therefore allow the flush valve to have precisely controlled and predictable volumes of water passing through the valve during the flushing cycle and enable the flush valve to be used in many different environments and with different types of toilet fixtures.

FIG. 6 is a front perspective view of hydraulic actuator 200 including actuating button 230 being mounted to a railing 224 coupled to receptacle 20. FIG. 6A is a rear perspective view of hydraulic actuator 200 including hydraulic lines 202 and 208 for manually actuating the automatic bathroom flusher. Hydraulic line 202 is in communication with the pilot pressure chamber at a connector 206 (FIGS. 5 and 5A). Hydraulic line 208 is in communication with cap 40. Upon manual actuation of actuating button 230, water flow from the pilot pressure chamber via hydraulic line 202 through hydraulic line 208 to outlet 36. Therefore, the water pressure in the pressure chamber is lowered, which causes the diaphragm to move upward; starts the manual water flush.

FIG. 6B is a cross-sectional view of the mechanical coupling between activation button 14 and hydraulic actuator 200. Activation button 14 includes a push button element 230 biased with a spring and coupled to a contact element 234. Contact element 234 touches actuating button 140. In this design, by depressing push button element 230, a user displaces actuating button 220 of hydraulic actuator 200.

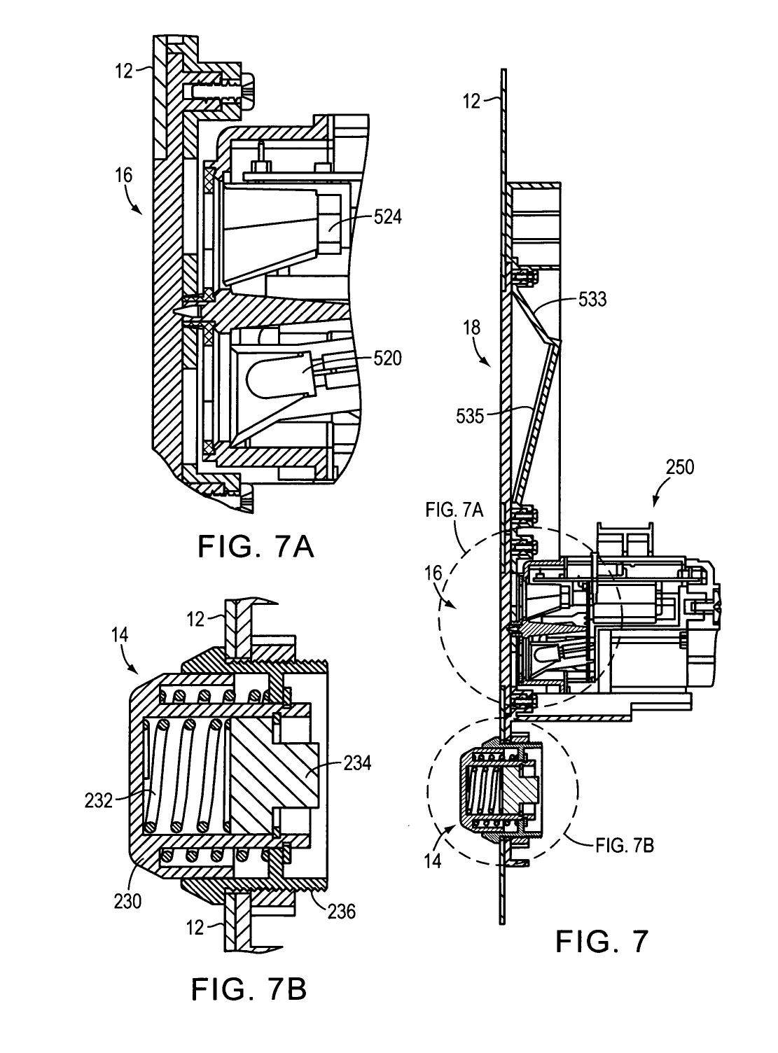

FIG. 7 is a side view of control wall panel 12 including electronic module 250, a photovoltaic panel 535, and manual push button 14, all mounted on the control wall panel 12. FIG. 7A is an enlarged side view the mounting of an infrared sensor including an IR light source 520 and an IR light detector 524 located behind optical window 16. FIG. 7B is an enlarged side view of manual push button 14, also shown in FIG. 6B.

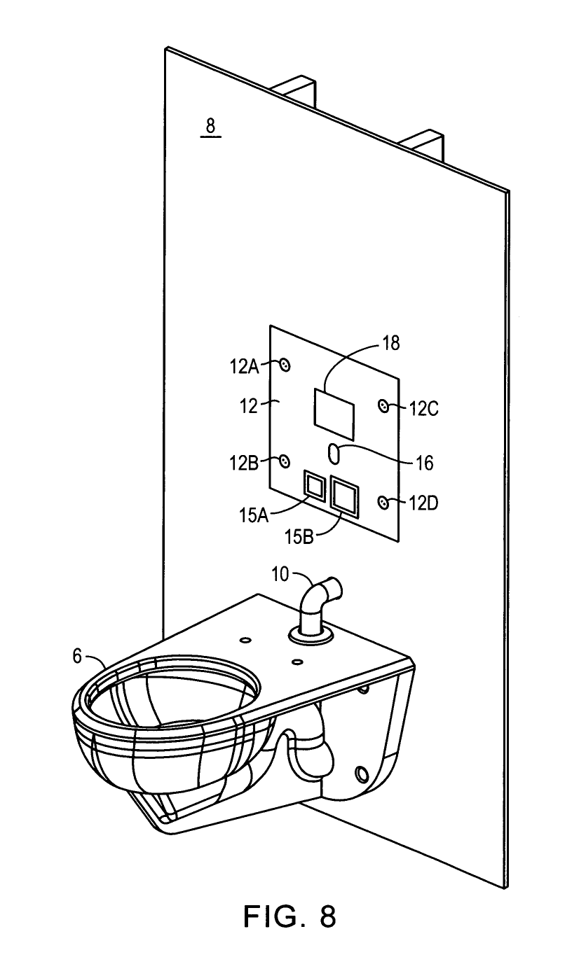

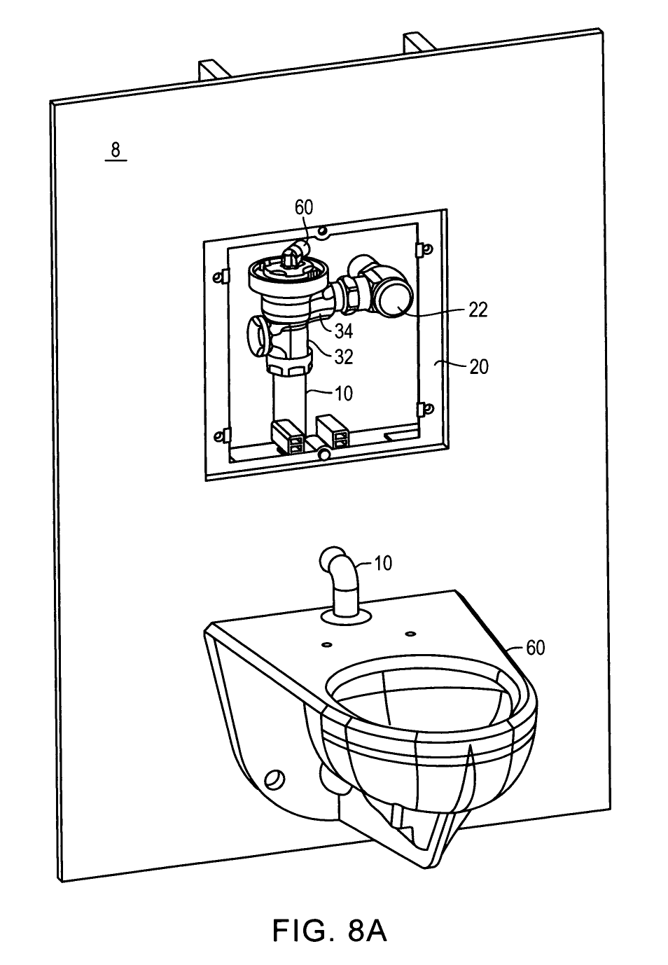

FIGS. 8 and 8A illustrate a perspective view of another embodiment of the control wall panel covering an automatic bathroom flusher concealed behind a bathroom wall and used for flushing a toilet. In this embodiment, mechanical activation buttons 14A and 14B and hydraulic actuator 200 are replaced by capacitive sensors, as described in the PCT Application PCT/US08/008242, which is incorporated by reference.

Advantageously, the photovoltaic cell panel 535 can be angled so that it collects the maximum amount of light from the ceiling as well as walls in the facility. During the initial installation, the design enables for hydraulic actuator 200 sliding movement back and forth. First the flush valve is installed and then receptacle box 20 with hydraulic actuator 200. Then hydraulic actuator 200 is pulled towards the front. Next control panel 12 is placed over receptacle box 20 with push button 14 on panel 12 aligned with hydraulic button 220. Push button 14 touches hydraulic button 220, as shown in FIG. 6 B, and pushes entire hydraulic actuator 200 slidably backwards just the right amount of distance for providing perfect coupling. Next control panel 12 is removed and hydraulic actuator 200 is secured to its place relative to receptacle box 20 using set screws or another type of fastener. Control panel 12 is then installed completing the installation.

When the control panel is removed, all hydraulic components stay in the wall and all electronic components stay with the panel. Once the solenoid wire is detached the panel can be serviced at any convenient location.

In the embodiments shown in FIGS. 1 and 1A, the flusher uses mechanical and hydraulic activation using hydraulic actuator 200. The actuation can be single or dual flush water volume. That is, the dual touch activation has one mechanical sensor (14A) for a reduced volume and the other mechanical sensor (14B) for a normal volume. The manual volume is controlled by the open time maintained in hydraulic actuator 200, which time provide for water flow from the pressure chamber via hydraulic line 202 to hydraulic line 208 and outlet 36.

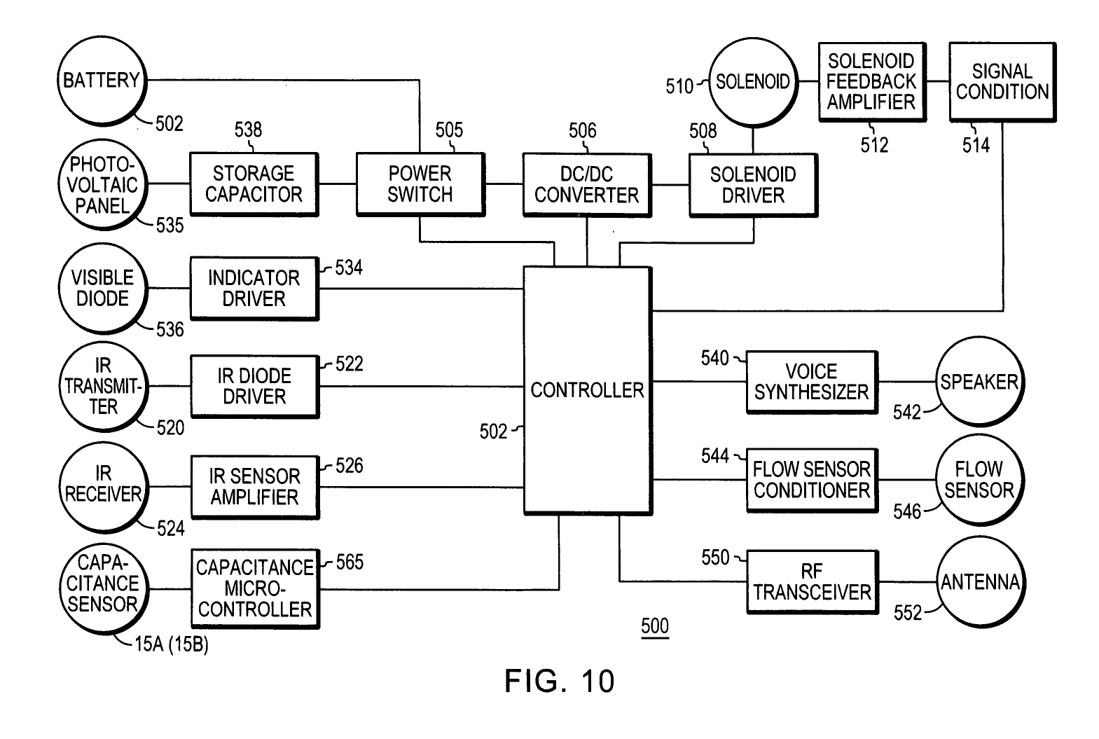

In the embodiments shown in FIGS. 8 and 8A, the flusher uses single or dual touch capacitance activation as described in the PCT Application PCT/US08/008242, which is incorporated by reference. That is, the dual touch capacitance activation has one capacitive sensor (15A) for a reduced volume and the other capacitive sensor (15B) for a normal volume. In this embodiment, each capacitive sensor is controller by a capacitance microcontroller 565 (FIG. 10), which in turn may control hydraulic actuator 200. The manual volume is again controlled by the open time of hydraulic actuator 200, which time provide for water flow from the pressure chamber via hydraulic line 202 to hydraulic line 208 and outlet 36.

Alternatively, capacitance microcontroller 565 may provide signals directly to controller 502 which executes activation of actuator 510 (i.e., actuator 60 in FIG. 3) for the flush cycle. In this embodiment hydraulic actuator 200 and hydraulic lines 202 and 208 are eliminated, as shown in FIG. 8A.

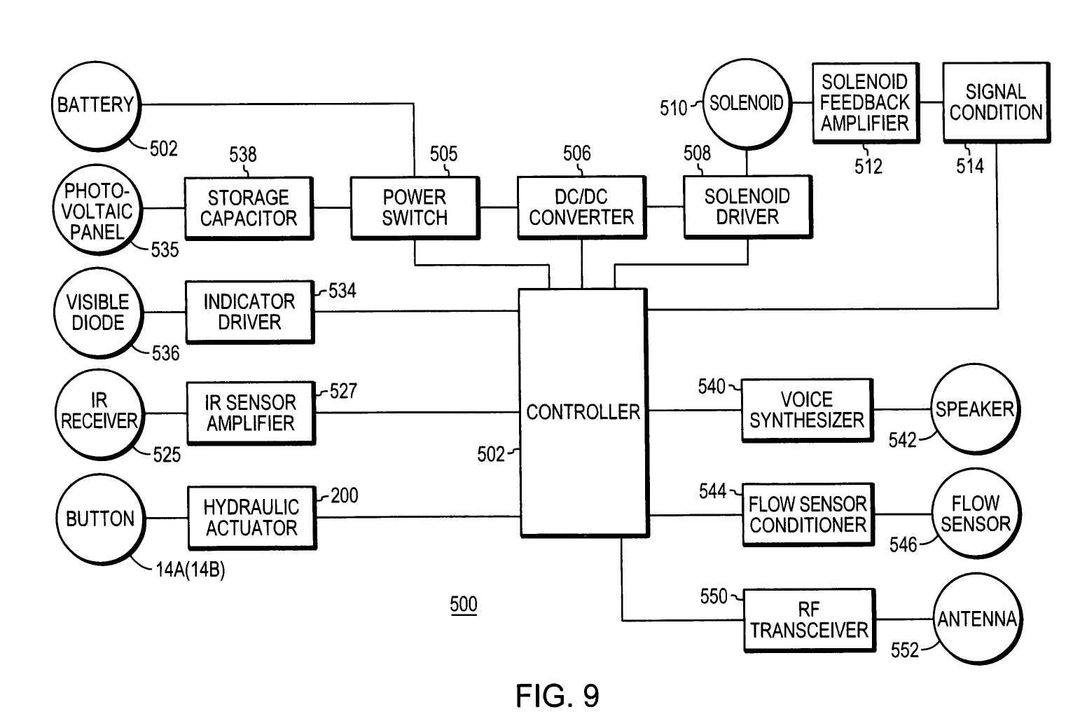

FIGS. 9 and 10 illustrate control electronics 500 used in the bathroom flusher described above. Several of the electronic elements shown in FIGS. 9 and 10 are optional and are used with various embodiments of the automatic bathroom flushers. The control electronics used with an active IR sensor is shown in FIG. 10. The active IR sensor includes an IR transmitter for emitting an IR beam and an IR receiver for detecting the reflected IR light.

The passive sensor uses passive optical detector with the control electronics is shown in FIG. 9. The passive sensor uses passive optical detector for detecting presence of a user as described as described in PCT Applications PCT/US03/38730 and PCT/US03/41303, both of which are incorporated by reference.

Referring to FIG. 9, control electronics 500 includes a controller 502 powered by a battery 503. Controller 502 is preferably a microcontroller MC9S08GT16A made by Freescale®. The microcontroller executes various detection and processing algorithms, which are preferably downloaded. However, the controller and algorithms may also be implemented in the form of dedicated logic circuitry, ASIC, or other. The control electronics 500 includes a power switch 505, a DC-DC converter 506, a solenoid driver 508. Solenoid driver 508 provides a drive signal to a solenoid 510 monitored by a solenoid feedback amplifier 512, and a signal conditioner 514. Controller 502 communicates with an indicator driver 534 for driving a visible diode 536 (e.g., a blue diode) for communications with the user. As shown in FIG. 10, the active optical sensor includes an IR diode driver 522 providing power to an IR transmitter 520, and an IR sensor amplifier 526 receiving a signal from an IR receiver 524. The entire operation is controlled by controller 502.

The IR diode driver 522 is designed to progressively increase and decrease the optical power output according to target and environment conditions. The same applies to the IR receiver using IR sensor amplifier 526. Usually only one of the modes is used both since one is enough to achieve the purpose. The following are examples of the conditions: If the environment is too IR bright, the system boosts the optical emission signal. If the target is too close, such as in the closet, the system reduces the IR signal to save power. If the target is not sufficiently IR reflective, the system boosts the IR signal either from the IR transmitter 520 or using IR sensor amplifier 526.

In the embodiment of FIG. 10, the system uses a capacitive controller, which monitors the activation of button 14 (or buttons 15A and 15B). The system also uses an optional voice synthesizer 540 connected to a speaker 542 for providing a user interface. An optional flow sensor conditioner 544 connected to a flow sensor 546 is used for detecting water flow through the flusher. Alternatively, a sensor may be used to detect overflow of water in a toilet or urinal and provide signal to controller 502 for shutting down the automatic flusher.

The system also uses an optional RF transceiver 550 connected to an antenna 552 for wireless communication with a remotely located central controller or network. The present design may be deployed with a network of wirelessly connected bathroom flushers and sanitary appliances. The remotely located network enables monitoring and gathering of information concerning the flushers and appliances. The communication between the flushers and appliances uses preferably low frequency RF signals, and the communication to the remotely located network node uses preferably a high frequency RF signals.

In general, wired or wireless data communication is used for transmitting information as it relates to the well being of the bathroom flushers and sanitary appliances. The transmitted information (together with the ID of the device) may include the battery voltage, number of flushes, the unit is on run-on condition (cannot turn off), no water condition (cannot turn on), etc. Using an RF transceiver 550 and antenna 552, the system can receive information such as command remotely initiated from somewhere else. The fixtures may talk to each other in a networked fashion. The fixtures may talk to a proximal central unit and this unit may transmit data (wired or wireless) to a wider network such as internet. In preferred a embodiment, the user initiates a location wide diagnostic mission by requesting each fixture to turn on and then off. In turn, each fixture reports successful/unsuccessful operation. The fixture may also report other variables such as battery voltage, number of flushes, etc. The user then gathers the information and schedules a maintenance routing according to results. This is particularly useful in establishments such as convention centers, ballparks, etc. where the maintenance personnel currently send crews to monitor the well being of the fixtures and take notes manually prior to an event.

Microcontroller MC9S08GT16A is used for the following main functions: Microcontroller 502 manages the voltage regulation for delivering fixed amount of voltage to sections of the hardware as needed regardless of the battery voltage (DC to DC converter). Microcontroller 502 monitors manual flush buttons. In case of capacitance touch, maintain necessary functions and adjustments as the background of the environment changes over time. Microcontroller 502 monitors target by use of IR emitter and receiver circuit and act accordingly. Microcontroller 502 provides necessary signal to solenoid so it would turn on and off. Microcontroller 502 maintains self monitoring such that if the executable software goes to a dead loop then it resets the program accordingly. Microcontroller 502 manages all user diagnostics input. Microcontroller 502 manages all mode settings. Microcontroller 502 monitors power source levels and takes action as necessary such as close the valve and shut down operation. Microcontroller 502 monitors solenoid latch and unlatch signals to conserve power.

Another embodiment of the control electronics is described in PCT Publications WO2005/056938 and WO2004/061343, both of which are incorporated by reference.

According to another embodiment, the control electronics includes a microcontroller that is an 8-bit CMOS microcontroller TMP86P807M made by Toshiba. The microcontroller has a program memory of 8 Kbytes and a data memory of 256 bytes. Programming is done using a Toshiba adapter socket with a general-purpose PROM programmer. The microcontroller operates at 3 frequencies (f_{c}=16 MHz, f_{c}=8 MHz and fₛ=332.768 kHz), wherein the first two clock frequencies are used in a normal mode and the third frequency is used in a low power mode (i.e., a sleep mode). The microcontroller operates in the sleep mode between various actuations. To save battery power, microcontroller periodically samples optical sensor unit for an input signal, and then triggers power consumption controller. Power consumption controller powers up signal conditioner and other elements. Otherwise, the optical sensor unit, the voltage regulator (or the voltage boost) and the signal conditioner are not powered to save battery power. During operation, the microcontroller also provides indication data to an indicator, e.g., a visible diode or a speaker. Control electronics may receive a signal from the passive optical sensor or the active optical sensor described above. A Low battery detection unit may be the low battery detector model no. TC54VN4202EMB, available from Microchip Technology. The voltage regulator may be the voltage regulator part no. TC55RP3502EMB, also available from Microchip Technology (http://www.microchip.com). Microcontroller may alternatively be a microcontroller part no. MCU COP8SAB728M9, available from National Semiconductor.

Control electronics 500 shown in FIG. 9 uses passive optical detector including a sensor amplifier 527 and an optical receiver 525. The passive optical detector is described in detail in PCT Publications WO2005/056938 and WO2004/061343, both of which are incorporated by reference.

Referring also to FIGS. 1 and 1A, bathroom flusher includes one or several photovoltaic cells 535 for producing voltage that is proportional to the amount of light that it receives. When system 500 powers up and starts operation, the system registers this voltage and continuously monitors the voltage thereafter. At first time power up, if there is no voltage from the photovoltaic cell, this means dark environment and therefore the unit marks the time and count for a predetermined amount of time. If the time is long enough, such as hours and days, and there is no target detected within the same period of time then the flusher system is powered up but nobody is using the bathroom (i.e., the lights are turned off) and therefore the system goes into a power saving mode. In this mode, the system scans for target at a much slower frequency to conserve battery power. The system may also shut down or slow down other functions such as scanning the override buttons, battery voltage, etc.

If there is no voltage from the photovoltaic cell, but yet the system acquires a valid target then the system indicates an error (that is, the photovoltaic cell is broken or malfunctioning or the connections and/or the circuit that relates to photovoltaic cell is broken.) In such case the system can disable all or some of the functionalities related to the photovoltaic cell. These functionalities are monitoring light or dark conditions of the environment, target shadow detection, power generation, etc.

After the first time power up, the system monitors if the photovoltaic cell function normally. In such case the module would monitor the photovoltaic cell voltage continuously (in normal operation mode). In cases, where the output voltage is sufficient, the system uses the corresponding energy for flushing, or stores the in a rechargeable device for later use. The rechargeable device may be a capacitor or a rechargeable cell/battery. If the photovoltaic cell voltage does not provide sufficient power for operation, there may be a condition where the target is casting shadow on the photovoltaic cell. In such case, the system uses the low voltage information as a supplement to the target detection algorithm, whereby prior to the condition the flusher may be in slow operation mode. In this mode of operation, the system conserves energy. Each target is detected using the detection algorithms (for the active or passive sensor) and the photovoltaic information provides a supplemental data.

If the system detects valid targets using the active or passive sensor algorithm, and yet the photovoltaic cell voltage is low or zero over several detection cycles, an error condition is indicated. In such case, the system deems the photovoltaic cell broken and ignores functionalities related to the photovoltaic cell, using just the battery power.

In general, solenoid actuator 60 (shown in FIGS. 2A and 3) or 510 (shown in FIGS. 9 and 10) includes a bobbin having magnetically wound electrical windings, and an armature linearly movable within the bobbin. The latching versions of the actuator include a ferromagnetic pole piece magnetically coupled to a permanent magnet acting against an armature spring. The permanent magnet is arranged for latching the armature in the open state. The armature spring maintains the armature in the extended position (i.e., the closed position with the plunger preventing flow through the passage). To flush the toilet, the microcontroller provides a control signal to a drive circuit that provides current to the solenoid windings of actuator 510. The drive current generates a magnetic field that tends to concentrate in a flux path in the ferromagnetic armature and the pole pieces as described in the PCT Application PCT/US01/51098. The latching actuator (i.e., bistable actuator) requires no current to keep the valve open.

In the non-latching versions, there is no permanent magnet to hold the armature in the open position, so a drive current must continue to flow if the pilot valve is to remain open (i.e., the drive current is needed to hold the plunger away from the pilot seat allowing flow through passage). The pilot valve can be closed again by simply removing the current drive. To close the pilot valve in the latching actuator, on the other hand, current must be driven through the windings in the reverse direction so that the resultant magnetic field counters the permanent-magnet field that the actuator experiences. This allows the armature spring to re-seat the plunger of actuator 510 in a position in which the spring force is again greater than the magnetic force. Then, the actuator will remain in the pilot-valve-closed position when current drive is thereafter removed.

The solenoid actuator may include a piloting button that is screwed onto the distal part of the solenoid actuator to create a valve, as described in the PCT applications PCT/US02/38758 and PCT/US02/41576, both of which are incorporated by reference. Specifically, the plunger of the solenoid actuator acts onto the valve seat inside the piloting button to control water flow between the input and output passages. This arrangement provides a reproducible and easily serviceable closure for this solenoid valve. This valve includes several O-rings providing tight water seals and preventing pressurized water from leaking and flooding the control module or the bathroom over time. It is important to note that these seals are not under compression. The seat member of the piloting button precisely controls the stroke of the solenoid plunger as mentioned above. It is desirable to keep this stroke short to minimize the solenoid power requirements.

The operation of the light source and detector and the entire control electronics is described in the PCT application PCT/US02/38758 (incorporated by reference). Another embodiment of the optical sensor is described in U.S. Pat. No. 6,212,697, which is incorporated by reference.

While the invention has been described with reference to the above embodiments, the present invention is by no means limited to the particular constructions described above and/or shown in the drawings. The present invention also comprises any modifications or equivalents within the scope of the following summarized paragraphs.

1. An automatic toilet room flusher system, comprising:
a valve body including an inlet and an outlet and a valve seat inside said body;
a valve member cooperatively arranged with said valve seat, said valve member being constructed and arranged to control water flow between said inlet and said outlet;
an electronic control module comprising a sensor and a controller; and
a control panel mounted with respect to a bathroom wall and designed to accommodate said electronic control module behind said bathroom wall.

2. The flusher system of claim 1 further including a photovoltaic cell mounted with respect to said control panel.

3. The flusher system of claim 1 wherein said control panel is cooperatively designed with a receptacle mounted behind said bathroom wall.

4. The flusher system of claim 1 further including an object sensor constructed and arranged to provide a signal to said controller.

5. The flusher system of claim 4 wherein said object sensor includes a capacitance sensor constructed and arranged to detect a user.

6. The flusher system of claim 4 wherein said object sensor includes an active optical sensor including an IR emitter and an IR detector.

7. The flusher system of claim 4 wherein said object sensor includes a passive optical sensor including a detector of ambient light.

8. The flusher system of claim 1 wherein said valve member constructed and arranged to control water flow between said inlet and said outlet includes a piston.

9. The flusher system of claim 1 wherein said valve member constructed and arranged to control water flow between said inlet and said outlet includes a diaphragm.

10. The flusher system of claim 1 wherein said valve member constructed and arranged to control water flow between said inlet and said outlet includes:
a diaphragm defining a pressure chamber with a pilot cover;
a water passage connecting said inlet and pressure chamber whereby the pressure in said chamber maintains said valve assembly upon said seat,
a flexible member fixed relative to said pilot cover at one end thereof, the other end of said flexible member being attached to said diaphragm, said flexible member including an inner passage opening to said outlet at one end thereof, a pilot passage connecting said pressure chamber with said flexible member passage,
a pilot mechanism including an electromagnetic actuator controlling flow through said pilot passage, movement of said diaphragm toward said cover, in response to venting of said pressure chamber causing said flexible member to bend while remaining stationary relative to said pilot cover.

11. The flusher system of claim 10 wherein said flexible member extends into said cover, a seal between said flexible member and cover, said seal remaining stationary during movement of said diaphragm assembly.

12. The flusher system of claim 11 wherein said flexible member is a hollow tube.

13-16. (canceled)

17. The flusher system of claim 1 wherein said valve member constructed and arranged to control water flow between said inlet and said outlet includes:
a pilot cover mounted upon said body and defining a pressure chamber with said valve member;
a water passage connecting said inlet and pressure chamber whereby the pressure in said pilot chamber maintains said valve assembly upon said seat;
a water vent associated with said pressure chamber permitting movement of said valve member toward said pilot cover;
a stroke limiter constructed to limit stroke of said valve member as it moves toward said cover including a stop fixed relative to said cover; and
a micro-control adjuster movable with said valve member and positioned to contact said stop upon venting of said pressure chamber and consequent movement of said valve assembly.

18-23. (canceled)

24. The flusher system of claim 4 wherein said object sensor includes an ultrasonic sensor.

25-26. (canceled)

27. The flusher system of claim 1 wherein said valve member includes a filter for filtering water.

28. The flusher system of claim 1 further including a manual override.

29. The flusher system of claim 28 wherein said manual override includes a hydraulic actuator.

30-34. (canceled)

35. A method of controlling a valve of a bathroom flusher, comprising
providing a valve body including an inlet and an outlet and a valve seat inside said body; providing a valve member cooperatively arranged with said valve seat, said valve member being constructed and arranged to control water flow between said inlet and said outlet;
providing an optical element located at an optical input port and arranged to partially define a detection field;
providing a light detector optically coupled to said optical element and said input port,
detecting ambient light arriving at said light detector;
providing a signal corresponding to said detected light from said light detector to a control circuit; and
controlling opening and closing of said valve member using said control circuit and said signal corresponding to the detected light.

36. The method of controlling a valve according to claim 35 including periodically sampling said light detector using said control circuit.

37-38. (canceled)

39. The method of controlling a valve according to claim 35 wherein said control circuit is constructed to adjust a sample period based on the detected amount of light after determining whether a facility is in use.

40. The method of controlling a valve according to claim 35 wherein said control circuit is constructed to cycle sleep and measurement periods
